(19) United States
(12) Patent Application Publication
(10) Pub. No.: US 2014/0067668 A1
(43) Pub. Date: Mar. 6, 2014

(54) Remote Safe Locking and Control

(71) Applicant: Dion L. Bellamy, St. Charles, MO (US)

(72) Inventor: Dion L. Bellamy, St. Charles, MO (US)

(73) Assignee: BANK OF AMERICA CORPORATION, Charlotte, NC (US)

(21) Appl. No.: 13/597,779

(22) Filed: Aug. 29, 2012

(51) Int. Cl. G06Q 40/02

(52) U.S. Cl. 705/43

(57) ABSTRACT

A system, method, and/or software for receiving by at least one computing device, over a network, an indication of an event at a first monetary deposit device; and determining by the at least one computing device, responsive to the event, whether to send a locking state command to a second monetary deposit device, and if so, sending the locking state command over the network to the second monetary deposit device.

### BACKGROUND

Automated teller machines and other monetary deposit devices traditionally include a safe for holding deposits until they can be picked up by an authorized service vendor. The safes may be lockable, and may be unlocked by the service vendor. However, there is insufficient network control over the locking mechanism.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

For instance, according to some aspects as described herein, a system, method, and/or software may provide at least the following functionality: receiving by at least one computing device, over a network, an indication of an event at a first monetary deposit device; and determining by the at least one computing device, responsive to the event, whether to send a locking state command to a second monetary deposit device, and if so, sending the locking state command over the network to the second monetary deposit device.

These and other aspects of the disclosure will be apparent upon consideration of the following detailed description.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a block diagram showing an example of at least a portion of a computing device that may be used to implement any of the elements of the other figures;

FIG. 2 is a block diagram showing an example of at least a portion of a system for controlling ATMs and/or other types of monetary deposit devices;

FIG. 3 is a block diagram showing an example of at least a portion of a monetary deposit device; and

FIG. 4 is a flow chart showing example steps that may be performed by a system such as the system of FIG. 2.

It is noted that one or more of the drawings may not necessarily be drawn to scale.

### DETAILED DESCRIPTION

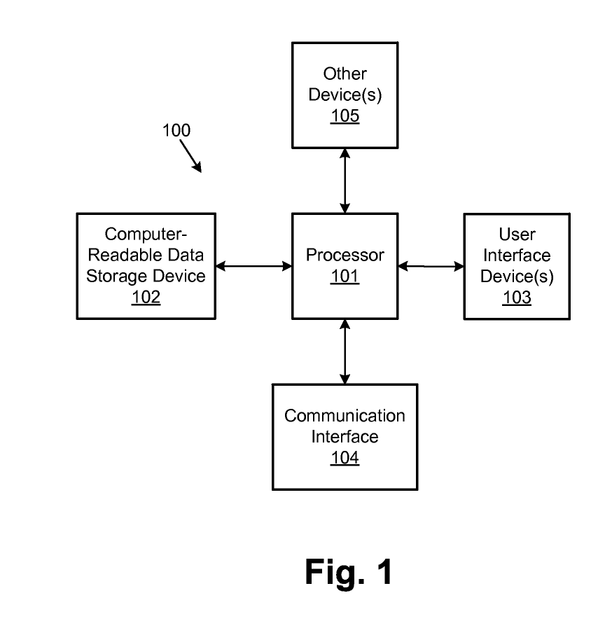

FIG. 1 is a block diagram of at least a portion of an example computing device 100 that may be used to partially or fully embody any or all of the elements in any of the other figures herein, such as but not limited to elements 201, 202, 203, 204, and 205. The computing device 100 may include hardware that may operate by, e.g., executing software to perform specific functions. The software, if any, may be stored by a computer-readable information storage device 102 in the form of computer-readable instructions. The computing device 100 may read those computer-readable instructions, and in response perform various steps as defined by those computer-readable instructions. Thus, any functions, steps, calculations, determinations discussed herein may be implemented by the computing device 100, such as by reading and executing computer-readable instructions for performing those functions, and/or by any hardware subsystem (e.g., a processor 101) from which the computing device 100 is composed. Additionally or alternatively, any of the above-mentioned functions may be implemented by the hardware of computing device 100, with or without the execution of software. For example, the computing device 100 may be or include one or more microprocessors, central processing units (CPUs), and/or other types of circuitry configured to perform some or all of the functions attributed to computing device 100. In such embodiments, the processor 101 may be implemented as or otherwise include the one or more microprocessors, CPUs, ASICs, and/or other types of circuitry.

A computing device may include any electronic, electro-optical, and/or mechanical device, or system of multiple physically separate or integrated such devices, that is able to process and manipulate information, such as in the form of data. Non-limiting examples of a computing device include one or more personal computers (e.g., desktop, tablet, or laptop), mainframes, servers, cellular phones (which may be “smart phones”), personal digital assistants, and/or a system of these in any combination or sub-combination. In addition, a given computing device may be physically located completely in one location or may be distributed amongst a plurality of locations (i.e., may implement distributive computing). A computing device may be or otherwise include a general-purpose computing device and/or a dedicated computing device configured to perform only certain limited functions.

The computer-readable information storage device 102 may be or otherwise include any type of computer-readable storage medium and may include not only a single tangible and/or non-transitory such medium or single type of such medium, but also a combination of one or more such media and/or types of such media. Examples of embodiments of the computer-readable information storage device 102 include, but are not limited to, one or more memories, hard drives, optical discs (such as CDs or DVDs), magnetic discs, magnetic tape drives, and other types of computer-readable information storage devices. The computer-readable information storage device 102 may be physically part of, or otherwise accessible by, the computing device 100, and may store the above-mentioned computer-readable instructions (e.g., software) and/or computer-readable data (i.e., information that may or may not be executable).

The computing device 100 may also include a user input/output interface 103 for receiving input from a user (e.g., via a keyboard, mouse, touch screen, an audio microphone, camera, and/or remote control) and/or for providing output to the user (e.g., via a touch screen or other display device, an audio speaker or piezoelectric element, an indicator light, a printer, and/or the like).

The computing device 100 may further include a communication input/output interface 104 for communicating with other devices via wire and/or wirelessly. Such communication with other devices may be direct or it may be indirect via a wired and/or wireless network.

The computing device 100 may further include and/or be coupled with one or more other devices 105, such as one or more peripherals, sensors, indicators, printers, displays, motors, and the like.

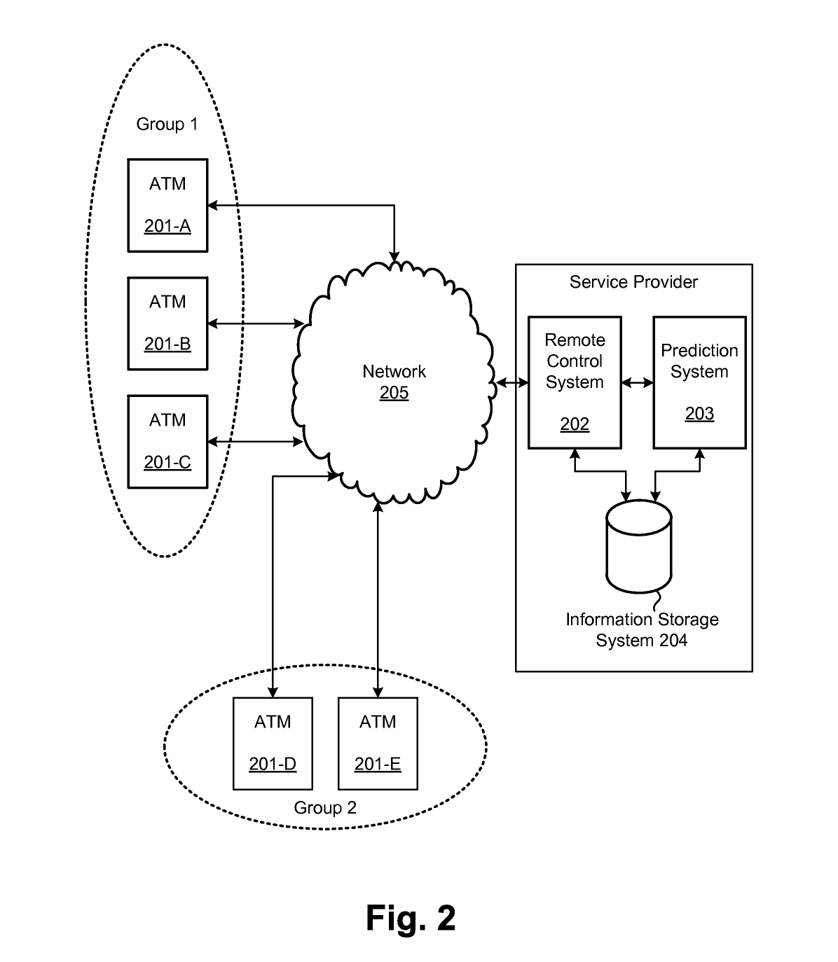

FIG. 2 is a block diagram showing an example of at least a portion of a system for controlling one or more monetary deposit devices. A monetary deposit device may be a device that is capable of receiving and/or providing money or other items (e.g., paper items such as paper currency, checks, and notes; coins; cards; and/or other items) from and/or to users of the monetary deposit machine. A monetary deposit device may be, for example, a fully or semi-fully automated device (e.g., providing self-service functionality to users), human-manned, and/or human-monitored. Non-limiting examples of monetary deposit devices may include automated teller machines (ATMs), video teller machines, cash recyclers, vaults, safes, and deposit boxes.

The example system of FIG. 2 may include a plurality of monetary deposit devices, shown here by way of example as ATMs 201. However, it will be understood that each of ATMs 201 may be any type of monetary deposit device. Moreover, each of the monetary deposit devices within the system of FIG. 2 may be the same type or may be of various combinations of different types. Further discussion of various example embodiments will typically refer to ATMs, and it will be understood that any types of monetary deposit devices may be substituted for the ATMs in those examples.

The ATMs 201 may be physically and/or logically groups into a plurality of groups. For example, ATMs 201-A, 201-B, and 201-C are shown by way of example as being part of Group 1, and ATMs 201-D and 201-E are shown by way of example as being part of Group 2. There may be more than two groups if desired, and each group may have any number of ATMs and/or other monetary deposit devices as desired. Each group may represent a subset of the total set of monetary deposit devices in the system, and the groups may be arranged based on any characteristics of the monetary deposit devices. For example, ATMs 201-A, B, and C may be in one geographic region (e.g., city, county, state, city block, arbitrary area of town, building, campus, and/or the like), and ATMs 201-D and E may be in another different geographic region. While Group 1 and Group 2 are shown as having completely different sets of ATMs, two or more groups may share one or more monetary deposit devices. For example, it may be desired that ATM 201-C be part of both Group 1 and Group 2. Thus, the various groups of monetary deposit devices may or may not overlap with one another.

The system of FIG. 2 may also include a service provider that may itself include one or more systems, such as a remote control system 202, a prediction system 203, and an information storage system 204. Systems 202-204 may be or otherwise include one or more computing devices, such as one or more servers. Moreover, systems 202-204 may be physically combined as one, two, three, or more separate systems and/or devices. Thus, for example, any of systems 202-204 may be combined as a single physical system and/or device. Moreover, any of systems 202-204 may be further subdivided into multiple physical systems and/or devices.

The system of FIG. 2 may further include one or more networks, such as network 205, that allows any of the elements in the system of FIG. 2 to communicate with each other bidirectionally or unidirectionally as desired. Such communications may include, for instance, transferring information such as in the form of digital data and/or analog signals. Network 205 may be wired and/or wireless and may be embodied as any one network or a combination of multiple networks, such as but not limited the Internet, a cellular telephone/data network, a landline telephone/data network, a wi-fi network, a local area network, a wide area network, and/or the like. Network 205 may be or otherwise include a smaller network, such as within a particular building, and/or a larger network, such as a network that extends throughout a state, a country, and/or the entire world.

Remote control system 202 may be configured to communicate with any of ATMs 201, such as by receiving and/or sending data, requests, queries, and/or commands between remote control system 202 and ATMs 201. For example, where it is described that one or more of ATMs 201 sends information such as status information, that information may be transferred over network 205 to remote control system 202. Likewise, where it is described that remote control system 202 sends information such as data, a query, or a command to one or more of ATMs 201, that information may be transferred over network 205 to ATMs 201. Where remote control system 202 includes a computing device such as example computing device 100, such information may be received and/or transmitted from/to network 205 via communication interface 105. Likewise, any other communications such as between remote control system 202 and prediction system 203, and information storage system 204, may be performed for example via communication interface 105.

Information storage system 204 may store information (such as in the form of data) at one or more computer-readable data information storage devices, such as one or more non-transitory computer-readable media. The information may include, for example, information representing one or more settings for locking ATMs 201, a status of each of ATMs 201 and/or of each group of ATMs, the physical locations of each ATM 201 and/or each ATM group, a history of ATM usage events (e.g., attempted and/or actual opening and/or closing of a safe of each ATM), and/or a history of any of the other above information. Information storage system 204 may also include one or more computing devices for managing the information stored by information storage system 204. The one or more computing devices may include, for example, a database server. Where information storage system 204 includes a computing device such as example computing device 100, such information may be received and/or transmitted from/to other systems and devices via communication interface 105.

For example, data storage system 204 may store information representing a schedule of events indicating when various monetary deposit devices are to be locked and/or unlocked, for instance as shown in Table 1. In this example, the data represents lock and/or unlock times for each of the monetary deposit devices. Remote control system 202 may read the schedule and send lock, disable, endable, and/or unlock commands (collectively referred to herein as locking state commands) via network 205 to the appropriate monetary deposit devices according to the schedule. For example, according to the schedule, remote control system 202 may send a particular command to ATM 201-A to lock at 8:00 pm every day (or on certain days), and to unlock at 6:00 am every day (or on certain days). The locking state command may be sent at the scheduled time (e.g., sent to ATM 201-A at 8:00 pm), or the command may be sent prior to the scheduled time and indicating the scheduled time (e.g., sent to ATM 201-A prior to 8:00 pm, and indicating that ATM 201-A should lock at 8:00 pm). Although a table is shown herein, the information may be stored in any format desired. Moreover, the schedule information may be stored so as to be searchable, such as using a queryable relational database capable of searching on any item of information as desired, such as searchable by column and/or row of Table 1. Also, of course, the specific items of information shown in Table 1 are merely examples.

TABLE 1

| DEVICE | GROUP | LOCK TIME | UNLOCK TIME |
|---|---|---|---|
| ATM | 1 | time/day 1 | time/day 2 |
| 201-A | | | |
| ATM | 1 | time/day 3 | time/day 4 |
| 201-B | | | |
| ATM | 1 | time/day 5 | time/day 6 |
| 201-C | | | |
| ATM | 2 | time/day 7 | time/day 8 |
| 201-D | | | |
| ATM | 2 | time/day 9 | time/day 10 |
| 201-E | | | |
| . . . | . . . | . . . | . . . |

Data storage system 204 may alternatively or additionally store information representing a history of when each monetary deposit device was opened, closed, locked, and/or unlocked, and/or of any other event of each monetary deposit device. Table 2 shows an example of such historical information. In the example of Table 2, one or more events are associated with one or more event times and one or more monetary deposit devices. Also, each event may be listed as scheduled or unscheduled. A scheduled event is an event that occurred (and was commanded) in accordance with the above-discussed schedule information. An unscheduled event is an event that did not occur in accordance with the schedule information. Although a table is shown herein, the information may be stored in any format desired. Moreover, the historical information may be stored so as to be searchable, such as using a queryable relational database capable of searching on any item of information as desired, such as searchable by column and/or row of Table 2. Also, of course, the specific information shown in Table 2 is merely an example.

TABLE 2

| EVENT | SCHEDULED | DEVICE | TIME |
|---|---|---|---|
| locked | yes | ATM 201-A | time/date 1; time/date 2, . . . |
| unlocked | yes | ATM 201-A | time/date 3; time/date 4, . . . |
| attempted | no | ATM 201-B | time/date 5 |
| unlock | | | |
| . . . | . . . | . . . | . . . |

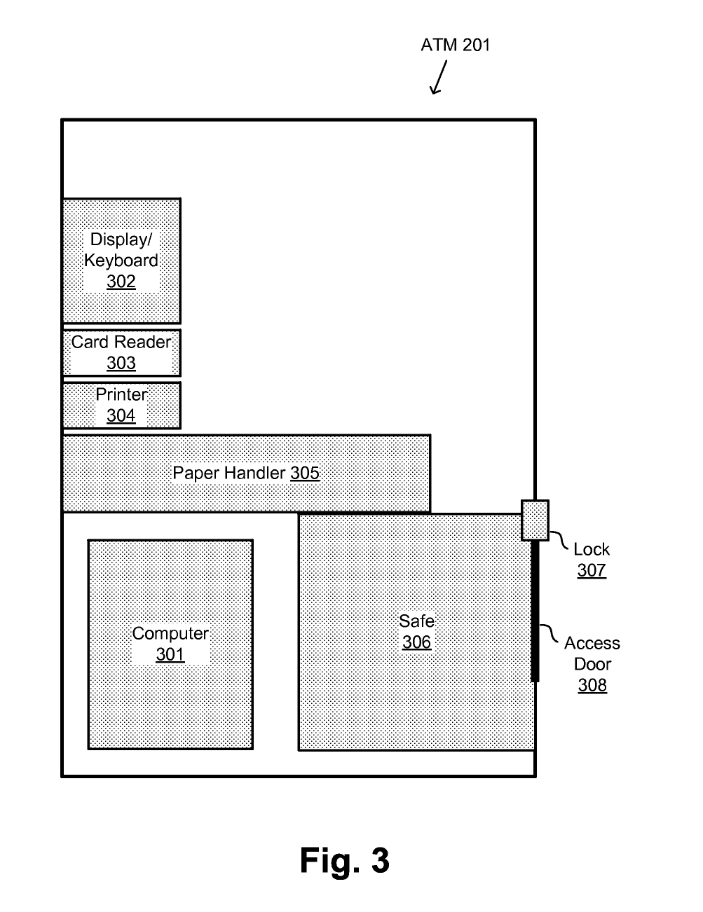

The historical information may be populated into data storage system 204 in accordance with sensed events. Events may be sensed, for example, by those of the monetary deposit devices (e.g., ATMs 201) at which the events occur. For instance, computer 301 may sense that a lock 307 (FIG. 3) of the ATM 201 is unlocked or lock, or that an attempted unlock has occurred (but failed). Computer 301 may send event information over network 205 to, e.g., remote control system 202. In response, remote control system 202 may update the historical information stored by data storage system 204 to include the identified event.

Prediction system 203 may be configured to receive information such as status information, commands, or queries from remote control system 202, and to make predictions as to whether a locking state command should be sent to one or more of ATMs 201 (e.g., commanded to be locked, unlocked, enabled, and/or disabled). The predictions may be based on, for example, information (e.g., data) retrieved from information storage system 204, information received from remote control system 202, and/or various predetermined operating rules (e.g., business rules). Where prediction system 203 includes a computing device such as example computing device 100, such information may be received and/or transmitted from/to other systems and devices via communication interface 105.

For example, prediction system 203 may use the historical information stored in data storage system 204 to make predictions as to whether a particular monetary deposit device or multiple such devices (e.g., group of devices) is at risk of an unauthorized attempted entry and should be locked down for security. Thus, for instance, based on the historical information indicating that ATM 201-A was attempted to be unlocked, and/or based on predetermined operating rules, prediction system 203 may predict that all ATMs 201 of the same group (Group 1) should be locked. Therefore, prediction system 203 may request remote control system 202 to lock down all of the Group 1 ATMs 201. In response, remote control system 202 may send locking state commands (e.g., lock commands) to all of the ATMs 201 in Group 1 (ATMs 201-A, 201-B and 20-C, in this example), or at least to all of the ATMs 201 in Group 1 that are not already locked. The particular predictions made and the particular resulting actions taken may vary—this is merely an example. In general, events detected at one or more monetary deposit devices may affect actions taken at one or more other monetary deposit devices. Moreover, the predictions made do not need to result in actions taken that are exclusive to or encompass only a single group; nor do the predictions need to apply to an entire group.

FIG. 3 is a block diagram of an example of how any of ATMs 201 (and/or other types of monetary deposit devices) may be configured. In this example, ATM 201 may include a computer 301, a display and/or keyboard 302 (e.g., a touch-sensitive display), a card reader 303 (e.g., a bank card reader), a printer 304 that may print transaction receipts, a paper handler 305, a safe 306, a lock 307, and an access door 308. Some or all of these elements may be partially or fully enclosed in a housing.

Computer 301 may be or otherwise include, for example, a computing device such as computing device 100. Computer 301 may control and coordinate operation of any or all of the other devices 302-307 of ATM 201. Computer 301 may also be responsible for communicating with networks and/or devices external to ATM 201, such as via network 205. Thus, where computer 301 includes a computing device such as computing device 100, such communication may occur via communication interface 104.

Paper handler 305 may include one or more devices configured to receive and/or present items such as paper items. For example, paper handler 305 may include a currency and/or check intake device and/or presentation device. Paper handler 305 may be further configured to count, scan, and/or otherwise process items handled by paper handler 305. Paper handler 305 may also include a storage area for storing currency, checks, coins, and/or other items processed by paper handler 305. Paper handler 305 may also be configured to provide items to safe 306 for storage therein.

Safe 306 may be configured to store items provided to it by paper handler 305. Typically, once items are stored in safe 306, those items may remain in the safe until safe 306 is opened via a special opening (e.g., access door 308) that can be opened and closed and those items are retrieved through the opening. The opening may be located anywhere, for example, on the housing of ATM 201, such as at the rear or side of ATM 201 as compared with display 302, which may be located at the front of ATM 201. However, the opening may be at the front of ATM 201 if desired. The opening (e.g., door 308) may be lockable so that the contents of safe 306 may not be accessed without first unlocking the opening. For instance, in the shown example, access door 308 may be selectably lockable via lock 307.

Lock 307 may be any type of lock, and may lock opening (e.g., access door 308) in any manner desired, such as via a physical bolt and/or magnetic actuator. Lock 307 may have the ability to switch between two or more logical and/or physical states, such as a locked state, an unlocked state, and/or a disabled state. In the locked state, lock 307 may inhibit physical opening of access door 308. In the unlocked state, lock 307 may no longer inhibit physical opening of access door 308. Lock 307 may be switched from the locked state to the unlocked state (and/or vice versa) via certain one or more inputs to lock 307, such as a local input (e.g., a physical key insertion and/or keypad-entered code) and/or a remote input (e.g., an unlock signal received via network 205, such as from the service provider). In either the locked or unlocked state, one or more additional locks may also be used to secure access door 308. Thus, for example, even when lock 307 is in the unlocked state, a person attempting to open access door 308 may need to unlock one or more other locks in order to open access door 308.

In the disabled state, lock 307 may inhibit physical opening of access door 308 and may also inhibit changing to the locked and/or unlocked state using the normal inputs that would otherwise change lock 307 to the unlocked state. For instance, in the disabled state, lock 307 may require even further and/or one or more different inputs in order to switch to the locked or unlocked state. The disabled state may be useful where, for instance, the service provider desires to prohibit opening of access door 308 by a person that may otherwise normally have authorization to open access door 308. The disable state may further be enacted only for a subset of inputs. For instance, where there are a plurality of persons authorized to unlock lock 307, each person having his or her own assigned unique unlock code (e.g., PIN), the disabled state may be set for one or some other subset of those unlock codes, while lock 307 may remain in a locked or unlocked (but not disabled) state for others of the unlock codes. Similarly, the locked state may further be enacted only for a subset of inputs. For instance, where there are a plurality of persons authorized to unlock lock 307, each person having his or her own assigned unique unlock code (e.g., PIN), the locked state may be set for one or some other subset of those unlock codes, while lock 307 may remain in the unlocked state for others of the unlock codes. Thus, in either case, this may provide the system with the ability to remotely shut off access by one or more particular individuals to one or more ATMs, as opposed to globally locking out the ATMs to all authorized individuals.

In addition to the state of lock 307 being controllable locally, such as by an ATM maintenance vendor, the state of lock 307 may be controlled remotely. For example, remote control system 202 may send a locking state command such as an unlock command, a lock command, a disable command, and/or an enable command to computer 301 of ATM 201, which may in turn cause lock 307 to attain the commanded logical and/or physical state. Where a physical state change is requested, lock 307 may include an electromechanical actuator (e.g., powered by an electrical servo motor) for changing the physical state. In some embodiments, lock 307 may be remotely locked and/or disabled, but not remotely unlockable. In such a case, the actuator may include, for instance, a one-way actuator that can push a locking mechanism into place and lock the safe remotely. This may be desired to provide additional security so that an unauthorized person gaining entry to the network may not remotely unlock ATM 201. In such embodiments, physical presence of a person at ATM 201 may, at a minimum, be required in order to unlock lock 307.

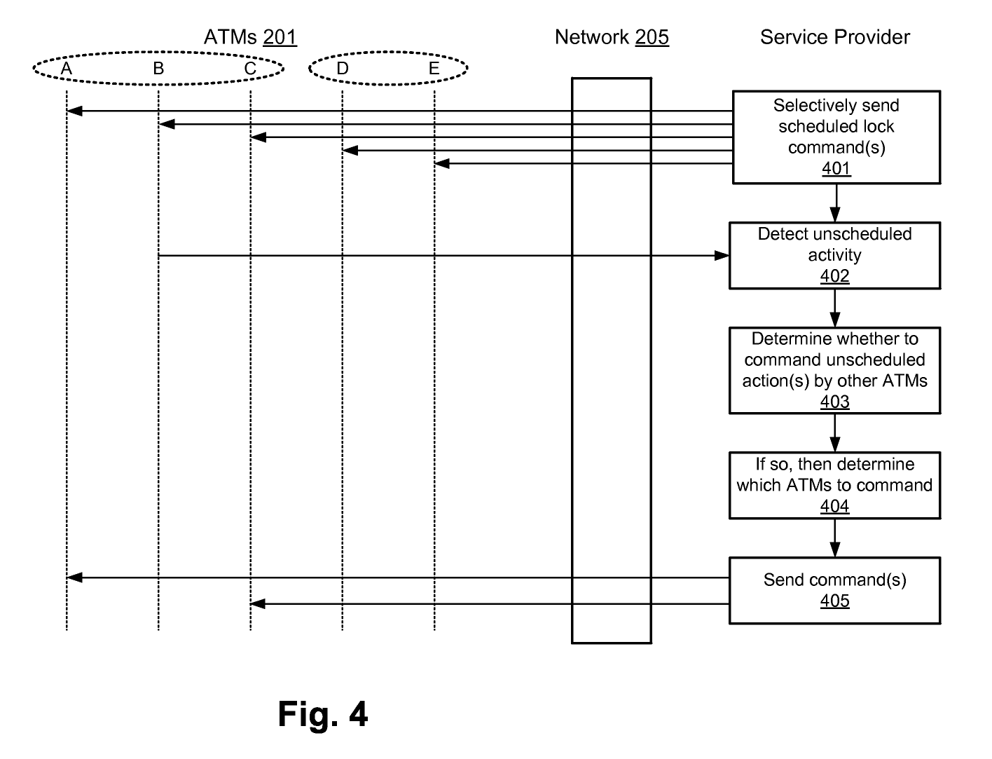

FIG. 4 is a flow chart showing example steps that may be performed by a system such as the system of FIG. 2. However, the steps of FIG. 4 may be performed by systems other than the example system of FIG. 2. While certain steps may be attributed as being performed by certain elements of FIG. 2, it will be understood that each of these steps may be performed by any one or more elements.

At step 401, remote control system 202 may selectively send locking state commands to the various ATMs 201 in accordance with the schedule information that may be stored in data storage system 204. Thus, for instance, if the schedule information indicates that ATM 201-A is to be locked or disabled, then remote control system 202 may send a lock or disable command to ATM 201-A via network 205. Computer 301 of ATM 201-A may receive the command and cause lock 307 to enter the appropriate state (e.g., locked or disabled). Step 401 may be performed on a continuous or intermittent basis, such as in parallel with performance of any of the other steps 402-45. Moreover, any of the steps may be performed in any order, sequentially, and/or in parallel with each other, and the steps may be broken into further steps and/or steps may be combined together.

At step 402, remote control system 202 may detect an unscheduled activity. For example, such detection by remote control system 202 may occur in response to receiving event information (e.g., a data message) via network 205 from one or more of the ATMs 201, in the example shown in FIG. 4, from ATM 201-B. The event information may be generated by computer 301 of the particular ATM 201-B. For example, a data message may be sent by computer 301 to remote control system 202, via network 205, that includes data that may indicate the type of event (e.g., attempted unlock, attempted access, locked, unlocked), the time that the event occurred (e.g., a particular time on a particular day), the identity of the ATM 201 at which the event occurred (e.g., ATM 201-B), the identity of the person initiating the event (e.g., the identity of the vendor personnel accessing ATM 201-B), the method of entry (e.g., key, PIN code entry), and/or any other factors associated with the event. Remote control system 202 may store information about the event (e.g., any of the above-listed information included in the message) in the above-discussed historical information in data storage system 204.

At step 403, prediction system 203 may use the stored historical information (which may include the above-discussed recent new event) to determine whether any unscheduled actions are to be commanded in addition to those already scheduled by the stored schedule information. Such a determination at step 403 may be performed at any time, such as in response to the update to the historical information at step 402, intermittently (for example, periodically), or continuously. At step 403, a determination that an unscheduled action is to be taken may result in a determination that an action is to be taken by one or more of the monetary deposit devices (e.g., one or more of ATMs 201). The unscheduled action may be a locking state command, for instance, a command to lock, a command to unlock, a command to disable the lock, and/or a command to enable the lock.

At step 404, if it is determined that other ATMs are to be sent such a command, then prediction system 203 may determine which other ATMs are to be sent the command. For example, prediction system 203 may determine that an indicated attempted unlocking of an ATM at a particular time (e.g., ATM 201-B), such as when the ATM is already locked or disabled, this may be indicative of unauthorized entry, and that nearby ATMs may also be at risk for unauthorized entry by the same individual. In that case, prediction system 203 may, for example, determine that one or more other ATMs, such as the other ATMs in the same group (e.g., Group 1) as the ATM in which the attempted unlock was performed (e.g., ATMs 201-A and 201-C), should be sent a command to lock and/or disable. Thus, in this example, in response to the message from ATM 201-B, a lock and/or disable command may be sent by remote control system 202 via network 203 to ATMs 201-A and 201-C. The commands may not be sent to other ATMs in the system, such as to the ATMs in other groups (e.g., Group 2). As mentioned previously, the groups (e.g., Group 1 and Group 2) may have been predetermined, such as based on the locations of the ATMs 201. If this is the case, then it may be sensible to command all ATMs within a particular group for a given action, since ATMs that are proximate to each other may be vulnerable to the same environmental risks. In other examples, groupings may not have been predetermined. In such a case, the ATMs determined at step 404 may be determined dynamically based on one or more factors. For example, the ATMs determined at step 404 may be those ATMs within a certain distance (e.g., radius) of the ATM at which the unscheduled activity was detected, and/or ATMs determined to have one or more characteristics similar to the ATM at which the unscheduled activity was detected.

At step 405, prediction system 203 may communicate with remote control system 202, requesting that remote control system 202 send the determined command(s) to the determined ATM(s). In response, remote control system 202 may send the indicated command(s) to the indicated ATM(s).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. A method, comprising:
receiving by at least one computing device, over a network, an indication of an event at a first monetary deposit device; and
determining by the at least one computing device, responsive to the event, whether to send a locking state command to a second monetary deposit device, and if so, sending the locking state command over the network to the second monetary deposit device.

2. The method of claim 1, wherein said determining comprises determining the second monetary deposit device from a plurality of monetary deposit devices based at least in part on a predetermined set of groupings of the monetary deposit devices.

3. The method of claim 1, wherein said indication of the event comprises an indication of an attempted unlocking of the first monetary deposit device.

4. The method of claim 1, wherein the first and second monetary deposit devices are each an automated teller machine (ATM).

5. The method of claim 1, wherein said determining comprises the at least one computing device determining whether to send the locking state command based on stored data representing a history of events at one or more monetary deposit devices.

6. The method of claim 1, wherein the locking state command comprises a lock command.

7. The method of claim 1, further comprising determining a subset of a plurality of monetary deposit devices, the subset being determined based on the first monetary deposit device, and the subset including the second monetary deposit device.

8. The method of claim 1, further comprising determining a subset of a plurality of monetary deposit devices that are located within a certain distance of the first monetary deposit device, the subset including the second monetary deposit device

9. At least one computer-readable information storage device storing computer-executable instructions for performing a method by one or more computing devices, the method comprising:
receiving by at least one computing device, over a network, an indication of an event at a first monetary deposit device;
determining by the at least one computing device, responsive to the event, whether to send a locking state command to a second monetary deposit device, and if so, sending the locking state command over the network to the second monetary deposit device.

10. The at least one computer-readable information storage device of claim 9, wherein said determining comprises determining the second monetary deposit device from a plurality of monetary deposit devices based at least in part on a predetermined set of groupings of the monetary deposit devices.

11. The at least one computer-readable information storage device of claim 9, wherein said indication of the event comprises an indication of an attempted unlocking of the first monetary deposit device.

12. The at least one computer-readable information storage device of claim 9, wherein the first and second monetary deposit devices are each an automated teller machine (ATM).

13. The at least one computer-readable information storage device of claim 9, wherein said determining comprises the at least one computing device determining whether to send the locking state command based on stored data representing a history of events at one or more monetary deposit devices.

14. The at least one computer-readable information storage device of claim 9, wherein the locking state command comprises a lock command.

15. The at least one computer-readable information storage device of claim 9, wherein the method further comprises determining a subset of a plurality of monetary deposit devices, the subset being determined based on the first monetary deposit device, and the subset including the second monetary deposit device.

16. A system, comprising:
a plurality of monetary deposit devices;
at least one computer-readable information storage device storing information identifying a plurality of groups of the monetary deposit devices;
at least one computing device configured to:
receive an indication of an event occurring at a first one of the monetary deposit devices;
determine which of the groups includes the first one of the monetary deposit devices; and
send a locking state command to at least some of the monetary deposit devices included in the determined group.

17. The system of claim 16, wherein said indication of the event comprises an indication of an attempted unlocking of the first one of the monetary deposit device.

18. The system of claim 16, wherein the first one of the monetary deposit devices is an automated teller machine (ATM).

19. The system of claim 16, wherein the at least one computer-readable information storage device further stores information representing a history of events that occurred at one or more of the monetary deposit devices, and wherein the at least one computing device is further configured to determine whether to send the locking state command based on the history of events.

20. The system of claim 16, wherein the locking state command comprises a lock command.
